(19) United States
(12) Patent Application Publication
(10) Pub. No.: US 2025/0277955 A1
(43) Pub. Date: Sep. 4, 2025

(54) VEHICULAR CAMERA

(71) Applicant: Panasonic Automotive Systems Co., Ltd., Kanagawa (JP)

(72) Inventor: Ken NAKAMURA, Kanagawa (JP)

(21) Appl. No.: 19/053,045

(22) Filed: Feb. 13, 2025

(30) Foreign Application Priority Data
Feb. 29, 2024 (JP) 2024-030433

(51) Int. Cl. G02B 7/02

(52) U.S. Cl. CPC G02B 7/02

(57) ABSTRACT

A vehicular camera includes a lens barrel, a circuit board, an imaging element, a first conductive member, and a housing. A large-diameter tubular portion of the housing includes a housing end surface, a first wall, a second wall, a third wall, and a fourth wall. The first conductive member includes a bottom surface portion located between inner and outer surfaces of the housing end surface, a first side surface portion located between the first inner side and outer side surfaces of the first wall, a second side surface portion located between the second inner side and outer surfaces of the second wall, a third side surface portion located between the third inner side and outer side surfaces of the third wall, and a fourth side surface portion located between the fourth inner side and outer side surfaces of the fourth wall.

### TECHNICAL FIELD

The present disclosure relates to a vehicular camera.

### BACKGROUND ART

With demands for improvements in vehicle safety, introduction of autonomous driving functions and the like in recent years, development of vehicular cameras that are mounted on vehicles and capture the inside and outside of the vehicles have become active (for example, see Patent Literatures 1 to 4).

### CITATION LIST

### Patent Literature

Patent Literature 1: U.S. Pat. No. 10,367,984B
Patent Literature 2: U.S. Pat. No. 10,506,141B
Patent Literature 3: U.S. Pat. No. 10,694,090B
Patent Literature 4: JP2017-147648A

### SUMMARY OF INVENTION

Required levels relating to safety, automatic driving functions, and the like, which are required for vehicles, are improved, and further improvement in performance and the like are also required for vehicular cameras.

The present disclosure relates to a technique for providing a new vehicular camera.

The present disclosure provides a vehicular camera. The vehicular camera includes a lens barrel including a first tubular portion having a first tubular shape along an optical axis and at least one lens disposed inside the first tubular portion and on the optical axis; a circuit board including a first surface and a second surface opposite to the first surface; an imaging element electrically connected to a circuit of the circuit board and disposed on the first surface of the circuit board on the optical axis; a first conductive member disposed to accommodate at least the circuit board and the imaging element; and a housing made of a resin and disposed to accommodate at least the circuit board and the imaging element, the housing including a second tubular portion having a second tubular shape along the optical axis. The second tubular portion of the housing includes: a housing end surface that at least partially faces the second surface of the circuit board and has a first shape including at least a first side, a second side, a third side, and a fourth side in a plan view of the housing; a first wall having a first inner side surface and a first outer side surface, and extending along the optical axis from the first side of the housing end surface in a direction away from the housing end surface; a second wall having a second inner side surface and a second outer side surface, and extending along the optical axis from the second side of the housing end surface in the direction away from the housing end surface; a third wall having a third inner side surface and a third outer side surface, and extending along the optical axis from the third side of the housing end surface in the direction away from the housing end surface; and a fourth wall having a fourth inner side surface and a fourth outer side surface, and extending along the optical axis from the fourth side of the housing end surface in the direction away from the housing end surface. The first conductive member includes: a bottom surface portion at least partially located between an inner surface of the housing end surface and an outer surface of the housing end surface, and having a second shape at least including a fifth side, a sixth side, a seventh side, and an eighth side in a plan view of the first conductive member; a first side surface portion at least partially extending from the fifth side of the bottom surface portion along the optical axis in a direction away from the bottom surface portion and located between the first inner side surface and the first outer side surface of the first wall of the second tubular portion of the housing; a second side surface portion at least partially extending from the sixth side of the bottom surface portion along the optical axis in the direction away from the bottom surface portion and located between the second inner side surface and the second outer side surface of the second wall of the second tubular portion of the housing; a third side surface portion at least partially extending from the seventh side of the bottom surface portion along the optical axis in the direction away from the bottom surface portion and located between the third inner side surface and the third outer side surface of the third wall of the second tubular portion of the housing; and a fourth side surface portion at least partially extending from the eighth side of the bottom surface portion along the optical axis in the direction away from the bottom surface portion and located between the fourth inner side surface and the fourth outer side surface of the fourth wall of the second tubular portion of the housing.

According to the present disclosure, the first conductive member that accommodates at least the circuit board and the imaging element has the bottom surface portion and the side surface portion. At least a part of the bottom surface portion is disposed between the inner surface of the housing end surface and the outer surface of the housing end surface, and at least a part of the side surface portion is disposed between the inner side surface and the outer side surface of the wall of the second tubular portion of the housing. Thus, it is possible to reduce the distance between the inner surface of the housing and a component such as a circuit board disposed inside the housing, and improve a heat dissipation effect.

### BRIEF DESCRIPTION OF DRAWINGS

FIG. 1 is an example of a vehicle, and is a top view of the vehicle on which vehicular cameras are mounted;

FIG. 2 is a block diagram illustrating a connection example of the vehicular cameras provided in the vehicle shown in FIG. 1, a camera ECU, and a display;

FIG. 3 is another example of the vehicle, and is a schematic diagram of a cabin of the vehicle on which a vehicular camera is mounted;

FIG. 4 is a top view of the vehicle in FIG. 3;

FIG. 5 is a block diagram illustrating a connection example of the vehicular camera provided in the vehicle shown in FIG. 3, a camera ECU, and a display device;

FIG. 6 is a front perspective view of the vehicular camera according to an embodiment;

FIG. 7 is a rear perspective view of the vehicular camera according to the embodiment;

FIG. 8 is an exploded perspective view of the vehicular camera according to the embodiment;

FIG. 9 is an exploded side view of the vehicular camera according to the embodiment;

FIG. 10 is a top view of the vehicular camera according to the embodiment;

FIG. 11 is a cross-sectional view taken along a line I-I in FIG. 9;

FIG. 12 is a top perspective view showing an inside of a housing;

FIG. 13 is a perspective view of a second conductive member; and

FIG. 14 is a bottom perspective view of a lens barrel bracket.

### DESCRIPTION OF EMBODIMENTS

Hereinafter, embodiments that specifically disclose a vehicular camera according to the present disclosure will be described in detail with reference to the drawings as appropriate. However, unnecessarily detailed descriptions may be omitted. For example, detailed descriptions of already well-known matters and redundant descriptions of substantially the same configuration may be omitted. This is to avoid unnecessary redundancy of the following descriptions and to facilitate understanding of those skilled in the art. It should be noted that the accompanying drawings and the following description are provided for those skilled in the art to fully understand the present disclosure, and are not intended to limit the subject matter described in the claims.

### Vehicle on Which Vehicular Camera is Mounted

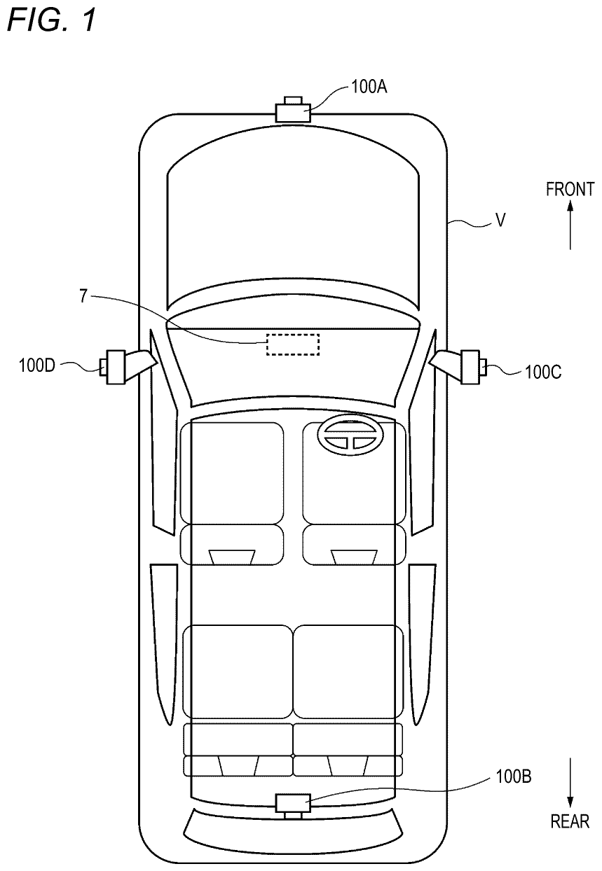

FIG. 1 is an example of a vehicle, and is a top view of the vehicle on which vehicular cameras are mounted. As a vehicular camera 100, a vehicular camera 100A, a vehicular camera 100B, a vehicular camera 100C, and a vehicular camera 100D are mounted on a vehicle V. The vehicular camera 100A is a front camera, the vehicular camera 100B is a rear camera, the vehicular camera 100C is a right side camera, and the vehicular camera 100D is a left side camera. The vehicular cameras 100A to 100D are, for example, wide-angle cameras having an angle of view of about 180°, and are disposed to capture images showing an entire periphery of the vehicle V.

For example, the vehicular camera 100A is provided in a front grille of the vehicle V, and captures an image of a front region in a direction of looking down obliquely with respect to the ground. The vehicular camera 100B is provided in a roof spoiler of the vehicle V, and captures an image of a rear region in a direction of looking down obliquely with respect to the ground. The vehicular camera 100C and the vehicular camera 100D are provided in side mirrors of the vehicle V, and capture images of lateral regions in directions of looking down obliquely with respect to the ground, respectively.

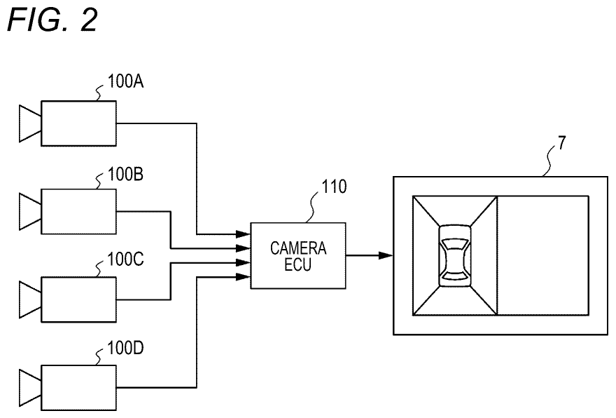

FIG. 2 is a block diagram illustrating a connection example of the vehicular cameras 100A to 100D provided in the vehicle V shown in FIG. 1, a camera ECU 110, and a display 7. The camera electronic control unit (ECU) 110 in FIG. 2 synthesizes the images captured by the vehicular cameras 100A to 100D, and displays a synthesized image on the display 7 of a navigation system disposed on an instrument panel, for example. An occupant can visually recognize the display 7 and check a situation around the vehicle V.

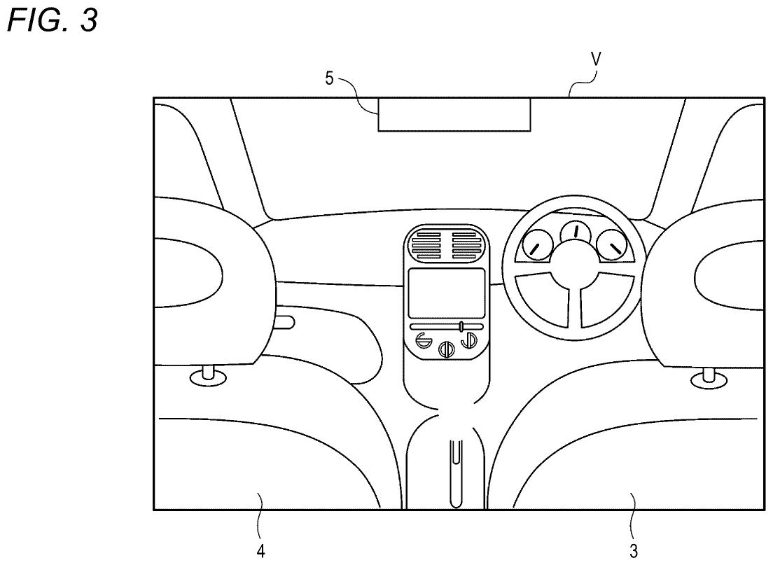

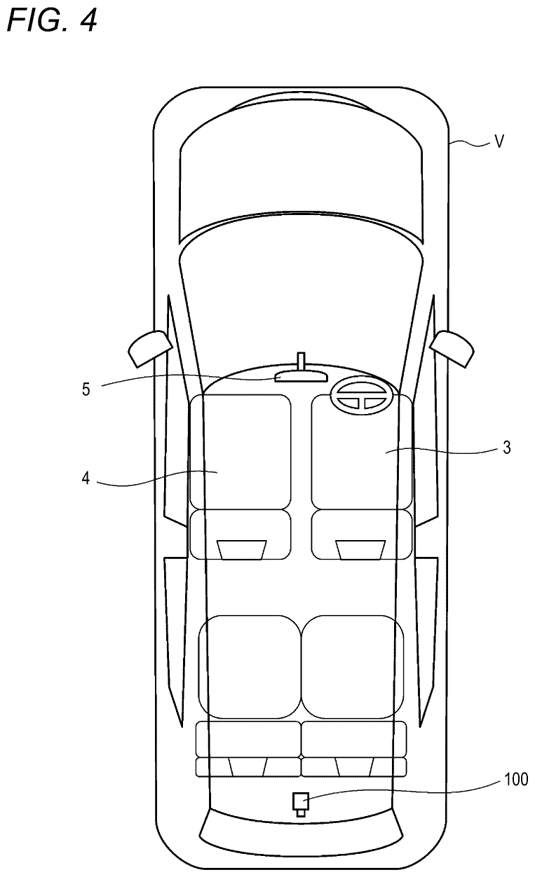

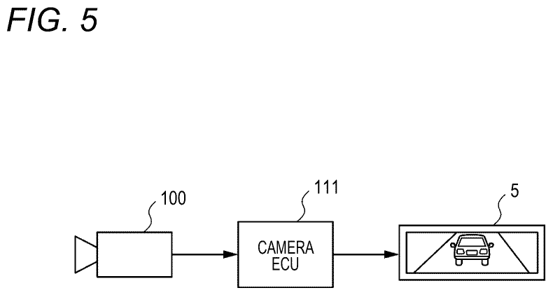

FIG. 3 is another example of the vehicle, and is a schematic diagram of a cabin of the vehicle on which the vehicular camera is mounted, and FIG. 4 is a top view of the vehicle in FIG. 3. The vehicle V includes a display device 5 (for example, an electronic rearview mirror) at an attachment position of a rearview mirror which is a front portion between a driver's seat 3 and a passenger seat 4 in a cabin 2. Further, the vehicle Vis provided with the vehicular camera 100 at a rear side of a vehicle body. FIG. 5 is a block diagram illustrating a connection example of the vehicular camera 100 provided in the vehicle V shown in FIG. 3, a camera ECU 111, and the display device 5. The camera electronic control unit (ECU) 111 in FIG. 4 processes an image captured by the vehicular camera 100, and the display device 5 displays the image. The occupant can visually recognize the display device 5 and check a rear situation of the vehicle V.

### Embodiment of Vehicular Camera

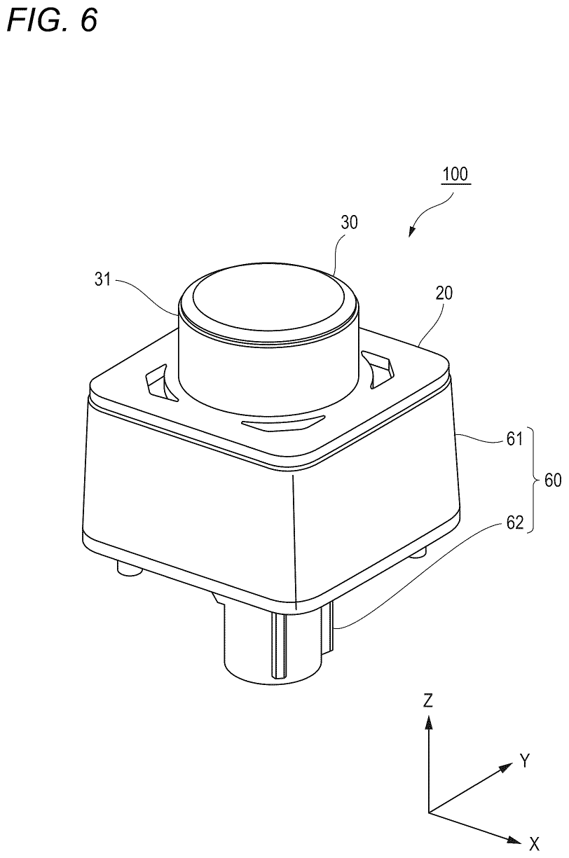

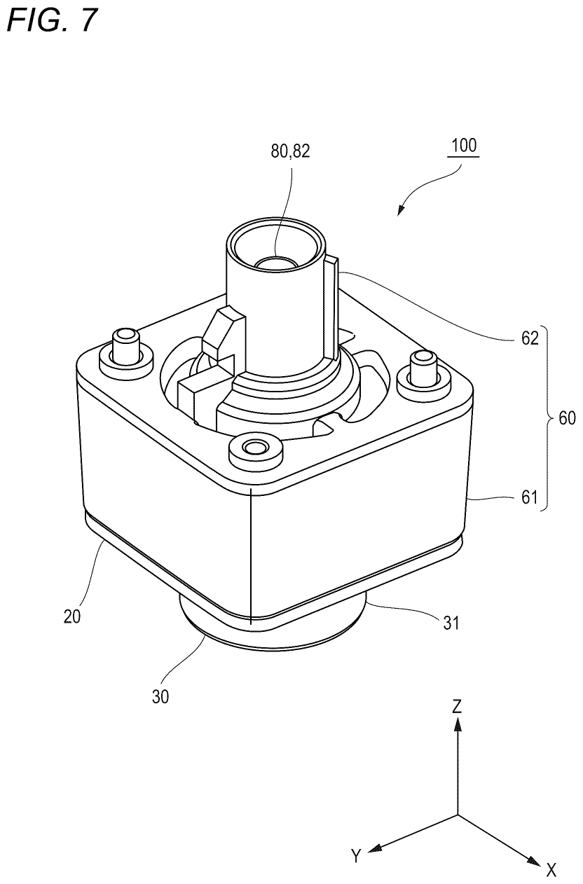

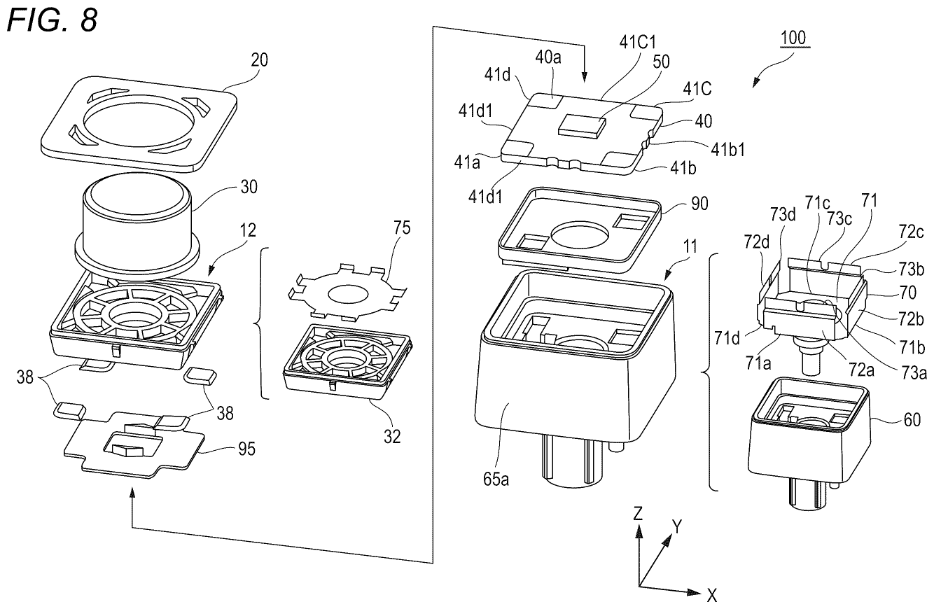

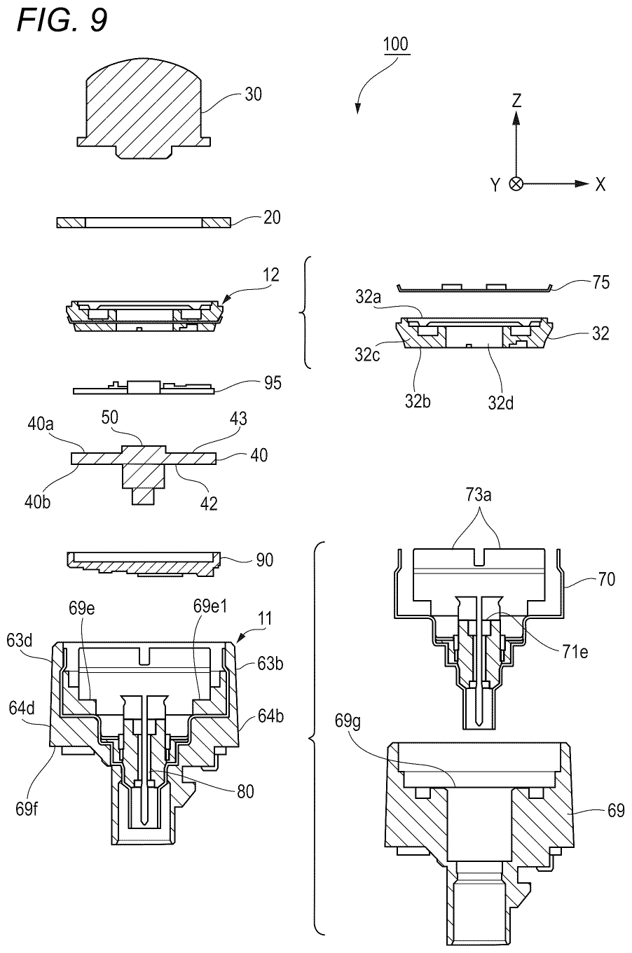

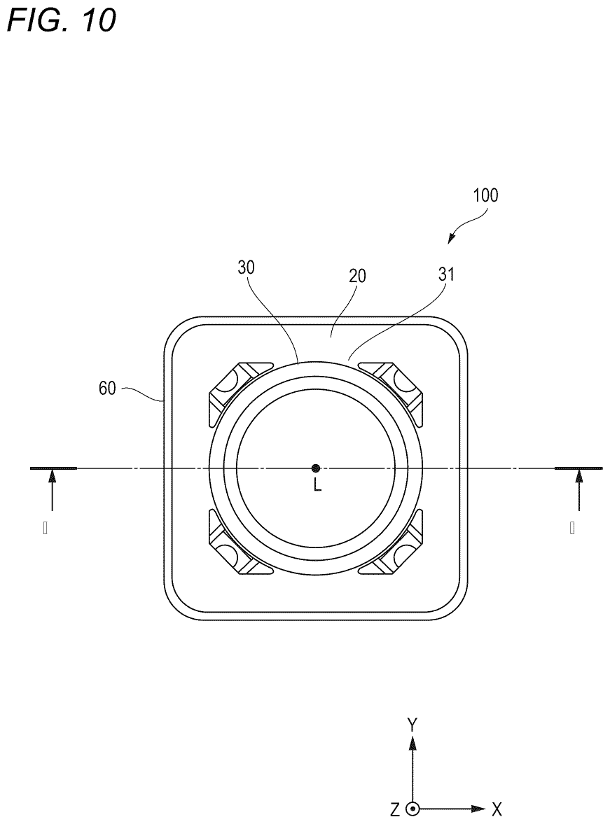

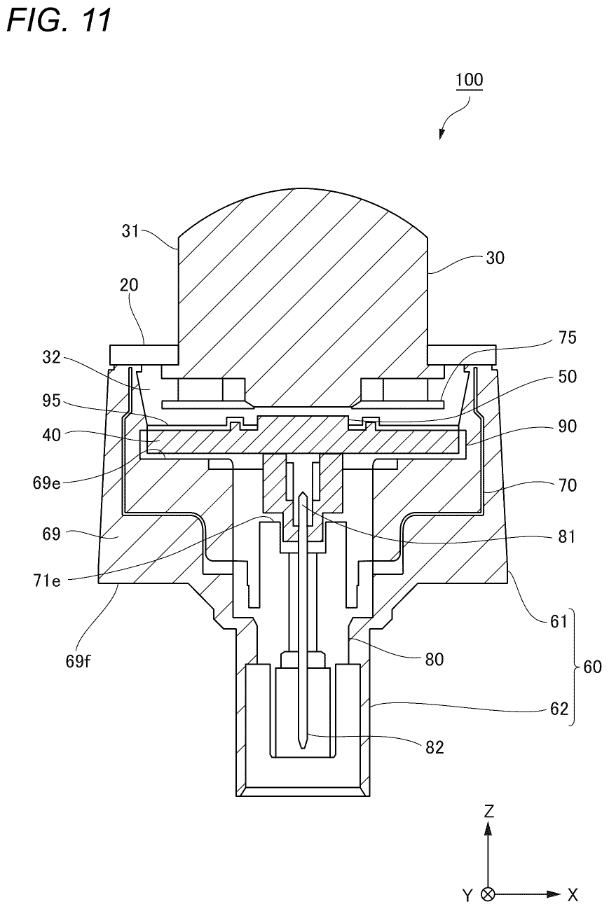

FIG. 6 is a front perspective view of the vehicular camera 100 according to an embodiment. FIG. 7 is a rear perspective view of the vehicular camera 100 according to the embodiment. FIG. 8 is an exploded perspective view of the vehicular camera 100 according to the embodiment. FIG. 9 is an exploded side view of the vehicular camera 100 according to the embodiment. FIG. 10 is a top view of the vehicular camera 100 according to the embodiment. FIG. 11 is a cross-sectional view taken along a line I-I in FIG. 10. Coordinates including an X axis along one side of the vehicular camera 100, a Y axis orthogonal to the X axis and along another side of the vehicular camera 100, and a Z axis orthogonal to the X axis and the Y axis and along a height direction of the vehicular camera 100 are defined, and are used in the following description.

The vehicular camera 100 according to the present embodiment includes a ring member 20, a lens barrel 30, a circuit board 40, an imaging element 50, a housing 60, a first conductive member 70, a first resin member 90, a second conductive member 75, a second resin member 95, and a lens barrel bracket 32. FIGS. 8 and 9 show respective perspective views of the first conductive member 70 and the housing 60, and a housing module 11 in which the first conductive member 70 and the housing 60 are combined, and show respective perspective views of the second conductive member 75 and the lens barrel bracket 32, and a bracket module 12 in which the second conductive member 75 and the lens barrel bracket 32 are combined.

The ring member 20 is implemented by a rectangular annular member having a flat plate shape in a plan view, and is welded to the lens barrel 30, the housing 60, and the lens barrel bracket 32 by laser welding. An inner peripheral surface of the ring member 20 faces an outer peripheral surface of a first tubular portion 31 (to be described below) of the lens barrel 30. An inner diameter of the ring member 20 has a length that allows the first tubular portion 31 of the lens barrel 30 to be inserted.

The ring member 20 can be formed of, for example, a resin. Accordingly, the ring member 20 can be easily formed at low cost.

The lens barrel 30 includes the first tubular portion 31 constituting a tubular lens barrel, and at least one lens that is accommodated inside the first tubular portion 31 and arranged on an optical axis L (an axis extending in a direction perpendicular to a paper surface of FIG. 10 and along the Z axis). The first tubular portion 31 has a tubular shape, and holds therein, for example, a lens group including a plurality of lenses. The respective lenses in the lens group are arranged in a state in which respective optical axes L are aligned with each other, and constitute the lens group used for capturing images of the inside and outside of the vehicle body of the vehicle V. The lens barrel 30 can be formed of, for example, a resin. Accordingly, the lens barrel 30 can be easily formed at low cost.

The circuit board 40 is disposed in an internal space of the housing 60, and includes a first surface 40a and a second surface 40b opposite to the first surface 40a. However, two or more circuit boards may be provided. The circuit board 40 has a circuit on at least one of the first surface 40a or the second surface 40b, but may have a circuit on both surfaces.

The circuit board 40 has a fourth shape having at least a thirteenth side 41a, a fourteenth side 41b, a fifteenth side 41c, and a sixteenth side 41d in a plan view of the circuit board 40 (a shape viewed in a direction of the optical axis L, that is, a direction along the Z axis, the same applies hereinafter). A third shape is, for example, a third quadrilateral shape, but may be a triangle or a polygon having pentagons or more sides. The circuit board 40 includes at least a first circuit board end surface 41a1 corresponding to the thirteenth side 41a, a second circuit board end surface 41b1 corresponding to the fourteenth side 41b, a third circuit board end surface 41c1 corresponding to the fifteenth side 41c, and a fourth circuit board end surface 41d1 corresponding to the sixteenth side 41d, which are located between the first surface 40a and the second surface 40b.

The imaging element 50 is disposed on the first surface 40a of the circuit board 40 and on the optical axis L of at least one lens of the lens barrel 30. The imaging element 50 is electrically connected to a circuit of the circuit board 40, and can capture an image by directing external light to the imaging element 50.

The housing 60 is a tubular member having the internal space, and serves to support the lens barrel 30 and accommodate at least the circuit board 40, the imaging element 50, and the first conductive member 70. The housing 60 has a large-diameter tubular portion 61 having a second tubular shape along the optical axis L, and a small-diameter tubular portion 62 along the optical axis L. The large-diameter tubular portion 61 constituting a second tubular portion has a larger cross-sectional area than the small-diameter tubular portion 62, and has a rectangular cross section. The large-diameter tubular portion 61 accommodates at least the circuit board 40 and the imaging element 50 therein. The small-diameter tubular portion 62 mainly accommodates a connector 80 that secures electrical connection with the outside of the vehicular camera 100 (to be described below). The large-diameter tubular portion 61 and the small-diameter tubular portion 62 may be integrally formed of a resin to be described later, and the large-diameter tubular portion 61 and the small-diameter tubular portion 62 prepared individually in advance may be joined by a method such as welding or screwing.

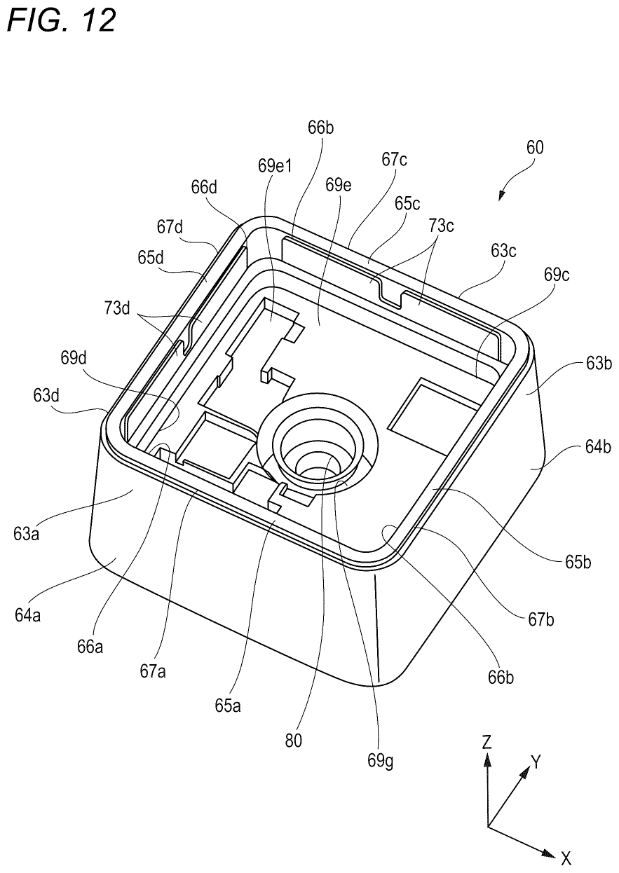

FIG. 12 is a top perspective view showing an inside of the housing 60. The large-diameter tubular portion 61 of the housing 60 includes a housing end surface 69, a first wall 65a, a second wall 65b, a third wall 65c, and a fourth wall 65d. The housing end surface 69 at least partially faces the second surface of the circuit board, and has a first shape including at least a first side 69a, a second side 69b, a third side 69c, and a fourth side 69d in a plan view of the housing. However, the first side 69a and the second side 69b are hidden by the first wall 65a and the second wall 65b and cannot be seen in FIG. 12. The first shape is, for example, a first quadrilateral shape, but may be a triangle or a polygon having pentagons or more sides.

The first wall 65a includes a first inner side surface 66a and a first outer side surface 67a, and extends along the optical axis L from the first side 69a of the housing end surface 69 in a direction away from the housing end surface 69. The first wall 65a further includes a first housing end portion 63a located between the lens barrel 30 and the housing end surface 69 of the housing 60, and a first housing protrusion 64a protruding in a direction away from the first housing end portion 63a with reference to the housing end surface 69 of the housing 60.

The second wall 65b includes a second inner side surface 66b and a second outer side surface 67b, and extends along the optical axis L from the second side 69b of the housing end surface 69 in the direction away from the housing end surface 69. The second wall 65b further includes a second housing end portion 63b located between the lens barrel 30 and the housing end surface 69 of the housing 60, and a second housing protrusion 64b protruding in a direction away from the second housing end portion 63b with reference to the housing end surface 69 of the housing 60.

The third wall 65c includes a third inner side surface 66c and a third outer side surface 67c, and extends along the optical axis L from the third side 69c of the housing end surface 69 in the direction away from the housing end surface 69. The third wall 65c further includes a third housing end portion 63c located between the lens barrel 30 and the housing end surface 69 of the housing 60, and a third housing protrusion 64c protruding in a direction away from the third housing end portion 63c with reference to the housing end surface 69 of the housing 60. However, in FIG. 12, the third housing protrusion 64c is hidden by the third wall 65c and cannot be seen.

The fourth wall 65d includes a fourth inner side surface 66d and a fourth outer side surface 67d, and extends along the optical axis L from the fourth side 69d of the housing end surface 69 in the direction away from the housing end surface 69. The fourth wall 65d further includes a fourth housing end portion 63d located between the lens barrel 30 and the housing end surface 69 of the housing 60, and a fourth housing protrusion 64d (see FIG. 9) protruding in a direction away from the fourth housing end portion 63d with reference to the housing end surface 69 of the housing 60. However, in FIG. 12, the fourth housing protrusion 64d is hidden by the fourth wall 65d and cannot be seen.

The first conductive member 70 is disposed to accommodate at least the circuit board 40 and the imaging element 50 in the internal space of the housing 60. The first conductive member 70 serves to shield electromagnetic wave noise coming from the outside of the housing 60 and electromagnetic wave noise to be radiated in the internal space. The first conductive member 70 is, for example, a metal such as aluminum or stainless steel. The first conductive member 70 may be formed by bending a single metal plate or by drawing.

The first conductive member 70 includes a flat bottom surface portion 71, a first side surface portion 72a, a second side surface portion 72b, a third side surface portion 72c, and a fourth side surface portion 72d. The bottom surface portion 71 is at least partially located between an inner surface 69e of the housing end surface 69 and an outer surface 69f of the housing end surface 69, and has a second shape at least including a fifth side 71a, a sixth side 71b, a seventh side 71c, and an eighth side 71d in a plan view of the first conductive member 70. The second shape is, for example, a second quadrilateral shape, but may be a triangle or a polygon having pentagons or more sides.

The first side surface portion 72a at least partially extends from the fifth side 71a of the bottom surface portion 71 along the optical axis L in a direction away from the bottom surface portion 71, and is located between the first inner side surface 66a and the first outer side surface 67a of the first wall 65a of the large-diameter tubular portion 61 of the housing 60. The second side surface portion 72b at least partially extends from the sixth side 71b of the bottom surface portion 71 along the optical axis L in the direction away from the bottom surface portion 71, and is located between the second inner side surface 66b and the second outer side surface 67b of the second wall 65b of the large-diameter tubular portion 61 of the housing 60. The third side surface portion 72c at least partially extends from the seventh side 71c of the bottom surface portion 71 along the optical axis L in the direction away from the bottom surface portion 71, and is located between the third inner side surface 66c and the third outer side surface 67c of the third wall 65c of the large-diameter tubular portion 61 of the housing 60. The fourth side surface portion 72d at least partially extends from the eighth side 71d of the bottom surface portion 71 along the optical axis L in the direction away from the bottom surface portion 71, and is located between the fourth inner side surface 66d and the fourth outer side surface 67d of the fourth wall 65d of the large-diameter tubular portion 61 of the housing 60.

That is, in the present embodiment, at least a part of the first conductive member 70 is embedded in the housing end surface 69 of the housing 60 and the four walls to constitute the housing module 11. Such a structure of the housing module 11 can be achieved by, for example, so-called insert molding in which the first conductive member 70 is embedded in the housing 60 when the housing 60 is molded.

In a vehicular camera in related art, a shield member corresponding to the first conductive member 70 is disposed on the inner surface of the housing. Further, an internal component such as a circuit board is disposed away from the shield member in order to avoid conduction due to contact with the shield member. As a result, the internal component is disposed away from the inner surface of the housing, and a space is formed around the internal component.

Since the internal component including the circuit board generate heat, it is necessary to dissipate the generated heat. However, due to the presence of the space, the heat dissipation effect may be reduced, and the function of the vehicular camera may be reduced.

In the present embodiment, the first conductive member 70 that accommodates at least the circuit board 40 and the imaging element 50 has the bottom surface portion 71 and the side surface portion. At least a part of the bottom surface portion 71 is disposed between the inner surface 69e of the housing end surface 69 and the outer surface 69f of the housing end surface 69, and at least a part of the side surface portion is disposed between the inner side surface and the outer side surface of the wall of the large-diameter tubular portion 61 of the housing 60. As a result, even when the internal component is disposed close to the inner surface of the housing 60, contact and conduction with the first conductive member 70 can be avoided. Thus, it is possible to reduce a distance between the inner surface of the housing 60 and the internal component such as the circuit board 40 disposed inside the housing 60, and improve the heat dissipation effect.

In addition, a first end portion 73a (see FIGS. 8 and 9) of the first side surface portion 72a of the first conductive member 70 is exposed to the inside of the housing 60 from a part of the first inner side surface 66a of the first wall 65a of the large-diameter tubular portion 61 of the housing 60. The first end portion 73a is exposed from the first housing end portion 63a of the first end portion 73a along the optical axis L, and is located more inward than the first housing protrusion 64a with reference to the optical axis L.

In addition, a second end portion 73b (see FIG. 8) of the second side surface portion 72b of the first conductive member 70 is exposed to the inside of the housing 60 from a part of the second inner side surface 66b of the second wall 65b of the large-diameter tubular portion 61 of the housing 60. The second end portion 73b is exposed from the second housing end portion 63b of the second end portion 73b along the optical axis L, and is located more inward than the second housing protrusion 64b with reference to the optical axis L.

In addition, as shown in FIG. 12, a third end portion 73c of the third side surface portion 72c of the first conductive member 70 is exposed to the inside of the housing from a part of the third inner side surface 66c of the third wall 65c of the large-diameter tubular portion 61 of the housing 60. The third end portion 73c is exposed from the third housing end portion 63c of the third end portion 73c along the optical axis L, and is located more inward than the third housing protrusion 64c with reference to the optical axis L.

In addition, as shown in FIG. 12, a fourth end portion 73d of the fourth side surface portion 72d of the first conductive member 70 is exposed to the inside of the housing 60 from a part of the fourth inner side surface 66d of the fourth wall 65d of the large-diameter tubular portion 61 of the housing 60. The fourth end portion 73d is exposed from the fourth housing end portion 63d of the fourth end portion 73d along the optical axis L, and is located more inward than the fourth housing protrusion 64d with reference to the optical axis L.

Accordingly, since the end portion of the side surface portion of the first conductive member 70 is exposed to the inside of the housing 60, a connection with another conductive member such as the second conductive member 75 described later can be secured, and the degree of freedom in designing a shielding effect by the conductive member can be increased.

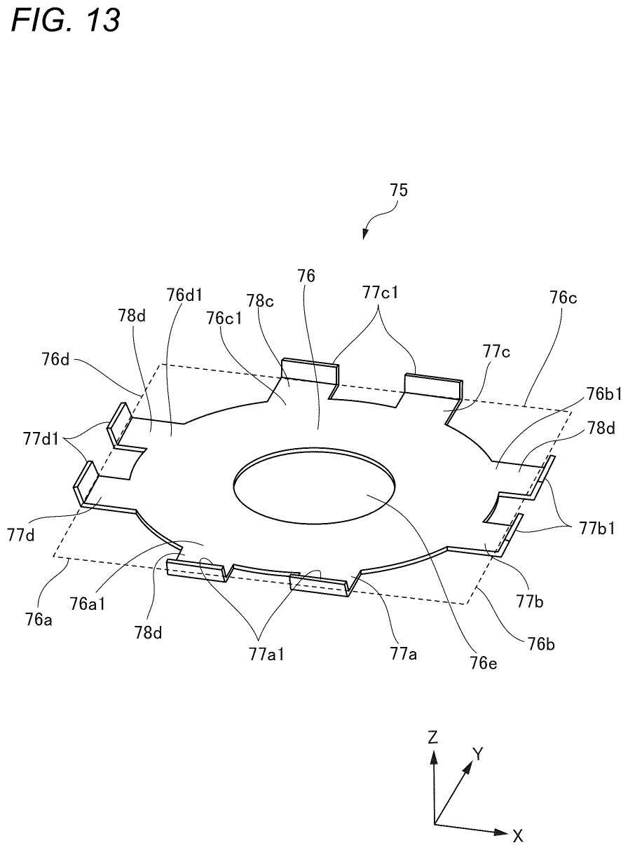

FIG. 13 is a perspective view of the second conductive member 75. The second conductive member 75 is at least partially disposed between the lens barrel 30 and the circuit board 40. Similarly to the first conductive member 70, the second conductive member 75 serves to shield electromagnetic wave noise coming from the outside of the housing 60 and electromagnetic wave noise to be radiated in the internal space. The second conductive member 75 is, for example, a metal such as aluminum or stainless steel. The second conductive member 75 may be formed by bending a single metal plate or by drawing.

The second conductive member 75 has a planar portion 76 having a third shape including at least a ninth side 76a, a tenth side 76b, an eleventh side 76c, and a twelfth side 76d in a plan view. The third shape is, for example, a third quadrilateral shape, but may be a triangle or a polygon having pentagons or more sides, or a circle including an ellipse.

The second conductive member 75 further includes a first contact portion 77a that is brought into contact with the first end portion 73a of the first side surface portion 72a of the first conductive member 70, in particular, an inner surface of the first end portion 73a, via a first contact 77a1.

Accordingly, since the second conductive member 75 in contact with the first conductive member 70 is provided, the shielding effect can be improved.

The second conductive member 75 includes a second contact portion 77b that is brought into contact with the second end portion 73b of the second side surface portion 72b of the first conductive member 70, in particular, an inner surface of the second end portion 73b, via a second contact 77b1. In addition, the second conductive member 75 includes a third contact portion 77c that is brought into contact with the third end portion 73c of the third side surface portion 72c of the first conductive member 70, in particular, an inner surface of the third end portion 73c, via a third contact 77c1. The second conductive member 75 further includes a fourth contact portion 77d that is brought into contact with the fourth end portion 73d of the fourth side surface portion 72d of the first conductive member 70, in particular, an inner surface of the fourth end portion 73d, via a fourth contact 77d1. Accordingly, since the second conductive member 75 is brought into contact with the first conductive member 70 via at least four contacts, the shielding effect by the second conductive member 75 can be reliably ensured.

In particular, the second conductive member 75 includes a first protrusion 78a protruding from a first portion 76a1 of the ninth side 76a of the planar portion 76 toward an inner surface of the first end portion 73a of the first conductive member 70. The second conductive member 75 includes a second protrusion 78b protruding from a second portion 76b1 of the tenth side 76b toward an inner surface of the second end portion 73b of the first conductive member 70. The second conductive member 75 includes a third protrusion 78c protruding from a third portion 76c1 of the eleventh side 76c toward an inner surface of the third end portion 73c of the first conductive member 70. The second conductive member 75 further includes a fourth protrusion 78d protruding from a fourth portion 76d1 of the twelfth side 76d toward an inner surface of the fourth end portion 73d of the first conductive member 70.

The first end portion 73a of the first side surface portion 72a of the first conductive member 70 is brought into contact with the first protrusion 78a of the second conductive member 75 via the first contact 77a1 of the second conductive member 75. The second end portion 73b of the second side surface portion 72b of the first conductive member 70 is brought into contact with the second protrusion 78b of the second conductive member 75 via the second contact 77b1 of the second conductive member 75. The third end portion 73c of the third side surface portion 72c of the first conductive member 70 is brought into contact with the third protrusion 78c of the second conductive member 75 via the third contact 77c1 of the second conductive member 75. The fourth end portion 73d of the fourth side surface portion 72d of the first conductive member 70 is brought into contact with the fourth protrusion 78d of the second conductive member 75 via the fourth contact 77d1 of the second conductive member 75.

Accordingly, since the protrusion protruding from the planar portion 76 of the second conductive member 75 is brought into contact with the end portion of the side surface portion of the first conductive member 70 via the contact, the contact between the first conductive member 70 and the second conductive member 75 can be made more reliable. The ninth side 76a, the tenth side 76b, the eleventh side 76c, and the twelfth side 76d may be defined along a portion where the protrusion of each side is bent toward the contact, as indicated by a rectangular broken line in FIG. 13.

The relationship between the circuit board 40 and the housing 60 will be described. At least a part of the first inner side surface 66a of the first wall 65a of the large-diameter tubular portion 61 of the housing 60 faces the first circuit board end surface 41a1 of the circuit board 40. At least a part of the second inner side surface 66b of the second wall 65b faces the second circuit board end surface 41b1 of the circuit board 40. At least a part of the third inner side surface 66c of the third wall 65c faces the third circuit board end surface 41c1 of the circuit board 40. At least a part of the fourth inner side surface 66d of the fourth wall 65d faces the fourth circuit board end surface 41d1 of the circuit board 40.

Accordingly, the circuit board 40 can be efficiently disposed inside the large-diameter tubular portion 61 of the housing 60.

The first resin member 90 has predetermined thermal conductivity and is disposed at least between the second surface 40b of the circuit board 40 and the inner surface 69e of the housing end surface 69 of the housing 60. Accordingly, since the first resin member 90 is disposed between the second surface 40b of the circuit board 40 and the inner surface 69e of the housing end surface 69, it is possible to reduce a space between the second surface 40b and the inner surface 69e and further improve the heat dissipation effect on the heat generated in the internal component.

The first resin member 90 is also disposed between the first inner side surface 66a of the first wall 65a of the large-diameter tubular portion 61 of the housing 60 and the first circuit board end surface 41a1 of the circuit board 40. In addition, the first resin member 90 is also disposed between the second inner side surface 66b of the second wall 65b of the large-diameter tubular portion 61 of the housing 60 and the second circuit board end surface 41b1 of the circuit board 40. In addition, the first resin member 90 is also disposed between the third inner side surface 66c of the third wall 65c of the large-diameter tubular portion 61 of the housing 60 and the third circuit board end surface 41c1 of the circuit board 40. Further, the first resin member 90 is also disposed between the fourth inner side surface 66d of the fourth wall 65d of the large-diameter tubular portion 61 of the housing 60 and the fourth circuit board end surface 41d1 of the circuit board 40.

Accordingly, since the first resin member 90 is also disposed between the inner side surface of the wall of the large-diameter tubular portion 61 of the housing 60 and the end surface of the circuit board 40, the heat dissipation effect can be further improved.

Furthermore, a plurality of first electronic components 42 are disposed on the second surface 40b of the circuit board 40 (see FIG. 9), and the inner surface 69e of the housing end surface 69 of the housing 60 has a plurality of first recesses 69e1 corresponding to the plurality of first electronic components 42.

Accordingly, since the first recesses 69e1 of the inner surface 69e of the housing end surface 69 correspond to the first electronic components 42 disposed on the second surface 40b of the circuit board 40, it is possible to reduce a gap between the inner surface 69e of the housing end surface 69 and the second surface 40b of the circuit board 40 and improve the heat dissipation effect.

In such a structure, the first resin member 90 may be disposed between the plurality of first electronic components 42 and the plurality of first recesses 69e1 of the inner surface 69e of the housing end surface 69. Accordingly, since the first resin member 90 is also disposed between the first electronic components 42 and the first recesses 69e1, the heat dissipation effect can be further improved.

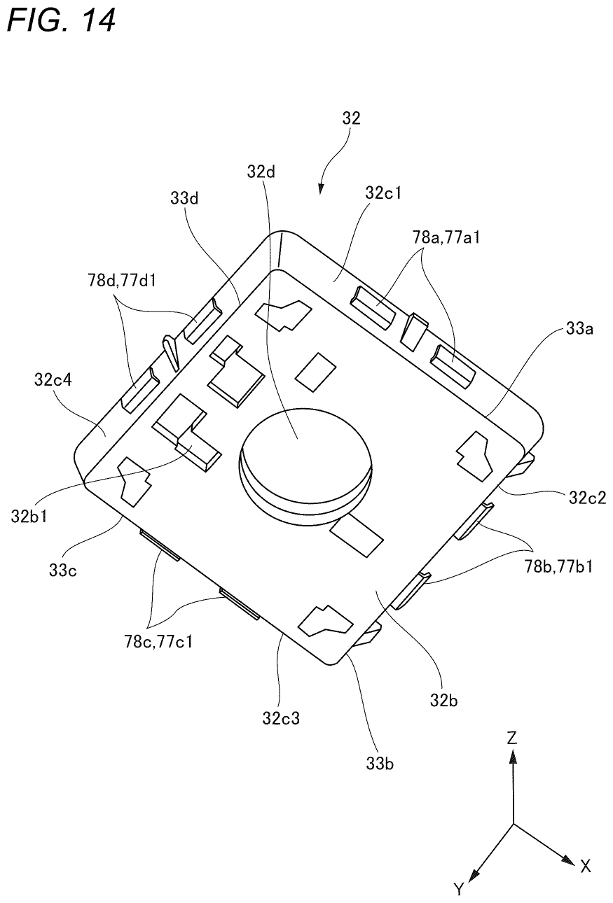

FIG. 14 is a bottom perspective view of the lens barrel bracket 32. The lens barrel bracket 32 is a resin member, at least a part of which is disposed between the lens barrel 30 and the first surface 40a of the circuit board 40. The lens barrel bracket 32 is connected to the housing 60 via the ring member 20 while supporting the lens barrel 30. The lens barrel bracket 32 has a fifth shape including at least a seventeenth side 33a, an eighteenth side 33b, a nineteenth side 33c, and a twentieth side 33d in a plan view. The fifth shape is, for example, a quadrilateral shape, but may be a triangular shape or a polygonal shape having pentagons or more sides.

The lens barrel bracket 32 includes a first bracket surface 32a, a second bracket surface 32b that is opposite to the first bracket surface 32a and at least partially faces the first surface 40a of the circuit board 40, and a bracket end surface 32c that connects the first bracket surface 32a and the second bracket surface 32b. The bracket end surface 32c includes at least a first bracket end surface 32c1, a second bracket end surface 32c2, a third bracket end surface 32c3, and a fourth bracket end surface 32c4.

Here, at least a part of the planar portion 76 of the second conductive member 75 is located between the first bracket surface 32a and the second bracket surface 32b of the lens barrel bracket 32. At least a part of the first protrusion 78a of the second conductive member 75, in particular, the first contact 77a1 is exposed from the first bracket end surface 32c1. At least a part of the second protrusion 78b, in particular, the second contact 77b1, is exposed from the second bracket end surface 32c2. At least a part of the third protrusion 78c, in particular, the third contact 77c1, is exposed from the third bracket end surface 32c3. At least a part of the fourth protrusion 78d, in particular, the fourth contact 77d1, is exposed from the fourth bracket end surface 32c4.

That is, in the present embodiment, at least a part of the second conductive member 75 is embedded in the lens barrel bracket 32 and constitutes the bracket module 12. Such a structure of the bracket module 12 can be achieved by, for example, insert molding in which the second conductive member 75 is embedded in the lens barrel bracket 32 when the lens barrel bracket 32 is molded.

Accordingly, since at least a part of the planar portion 76 of the second conductive member 75 is disposed inside the lens barrel bracket 32, a distance between the second bracket surface 32b of the lens barrel bracket 32 and the internal component such as the circuit board 40 disposed inside the housing 60 can be reduced, and the heat dissipation effect can be improved.

The second resin member 95 has predetermined thermal conductivity and is disposed at least between the first surface 40a of the circuit board 40 and the second bracket surface 32b of the lens barrel bracket 32. Accordingly, a space between the first surface 40a of the circuit board 40 and the second bracket surface 32b of the lens barrel bracket 32 can be reduced, and the heat dissipation effect on the heat generated in the internal component can be further improved.

Further, a plurality of second electronic components 43 are disposed on the first surface 40a of the circuit board 40 (see FIG. 9), and the second bracket surface 32b of the lens barrel bracket 32 has a plurality of second recesses 32b1 corresponding to the plurality of second electronic components 43.

Accordingly, since the second recesses 32b1 of the second bracket surface 32b correspond to the second electronic components 43 disposed on the first surface 40a of the circuit board, it is possible to reduce a gap between the second bracket surface 32b and the second surface 40b of the circuit board 40 and improve the heat dissipation effect.

In this structure, the second resin member 95 may be disposed between the plurality of second electronic components 43 disposed on the first surface 40a of the circuit board 40 and the plurality of second recesses 32b1 of the second bracket surface 32b of the lens barrel bracket 32. Accordingly, since the second resin member 95 is also disposed between the second electronic components 43 and the second recesses 32b1, the heat dissipation effect can be further improved.

The second resin member 95 can be disposed to surround the imaging element 50 disposed on the first surface 40a of the circuit board 40. Accordingly, it is possible to improve the heat dissipation effect while ensuring the function of the imaging element 50.

As shown in FIG. 8, at least a part of the second bracket surface 32b of the lens barrel bracket 32 may be bonded to the first surface 40a of the circuit board 40 with at least one adhesive 38. Accordingly, the circuit board 40 can be stably disposed inside the large-diameter tubular portion 61 of the housing 60.

Further, the lens barrel bracket 32 has a first hole 32d corresponding to the optical axis L and penetrating the first bracket surface 32a and the second bracket surface 32b, and the second conductive member 75 has a second hole 76e corresponding to the first hole 32d of the lens barrel bracket 32 in the planar portion 76.

Accordingly, the first hole 32d of the lens barrel bracket 32 and the second hole 76e of the second conductive member 75 correspond to each other, and thus light from the outside can be introduced into the inside of the housing 60.

Further, the bottom surface portion 71 of the first conductive member 70 has a third hole 71e penetrating the bottom surface portion 71, and the housing 60 has a fourth hole 69g corresponding to the third hole 71e of the first conductive member 70 and penetrating the housing end surface 69. The vehicular camera 100 is provided with the connector 80 that penetrates the third hole 71e and the fourth hole 69g and is electrically connected to the circuit of the circuit board 40. The first resin member 90 is disposed to surround the connector 80. Accordingly, the connector 80 can ensure electrical connection between the vehicular camera 100, the outside, and a power supply.

The connector 80 includes a first connector end 81 disposed inside the housing 60 and electrically connected to the circuit of the circuit board 40, and a second connector end 82 opposite to the first connector end 81 and disposed in the fourth hole 69g of the housing end surface 69 of the housing 60. When the vehicular camera 100 is disposed in the vehicle V, the second connector end 82 of the connector 80 is electrically connected to a wire of the vehicle V. Accordingly, the connector 80 can ensure electrical connection between the vehicular camera 100 and the wire of the vehicle V.

The first resin member 90 and the second resin member 95 may include a magnetic material such as ferrite. Accordingly, the shielding effect can also be imparted to the resin member.

The first resin member 90 may be brought into contact with the second resin member 95. When the first resin member 90 is brought into contact with the second resin member 95, heat generated from the circuit board 40 can be more efficiently conducted to the housing 60.

From the above, at least the following matters are described in the present disclosure. Components corresponding to those in the embodiment are shown in parentheses, but the present disclosure is not limited thereto.
(1) A vehicular camera (vehicular camera 100) including:
a lens barrel (lens barrel 30) including a first tubular portion (first tubular portion 31) having a first tubular shape along an optical axis (optical axis L) and at least one lens disposed inside the first tubular portion and on the optical axis;
a circuit board (circuit board 40) including a first surface (first surface 40a) and a second surface (second surface 40b) opposite to the first surface;
an imaging element (imaging element 50) electrically connected to a circuit of the circuit board and disposed on the first surface of the circuit board on the optical axis;
a first conductive member (first conductive member 70) disposed to accommodate at least the circuit board and the imaging element; and
a housing (housing 60) made of a resin, the housing being disposed to accommodate at least the circuit board and the imaging element and including a second tubular portion (large-diameter tubular portion 61) having a second tubular shape along the optical axis, in which
the second tubular portion of the housing includes:
a housing end surface (housing end surface 69) that at least partially faces the second surface of the circuit board and has a first shape including at least a first side (first side 69a), a second side (second side 69b), a third side (third side 69c), and a fourth side (fourth side 69d) in a plan view of the housing;
a first wall (first wall 65a) having a first inner side surface (first inner side surface 66a) and a first outer side surface (first outer side surface 67a), and extending along the optical axis from the first side of the housing end surface in a direction away from the housing end surface;
a second wall (second wall 65b) having a second inner side surface (second inner side surface 66b) and a second outer side surface (second outer side surface 67b), and extending along the optical axis from the second side of the housing end surface in the direction away from the housing end surface;
a third wall (third wall 65c) having a third inner side surface (third inner side surface 66c) and a third outer side surface (third outer side surface 67c), and extending along the optical axis from the third side of the housing end surface in the direction away from the housing end surface; and
a fourth wall (fourth wall 65d) having a fourth inner side surface (fourth inner side surface 66d) and a fourth outer side surface (fourth outer side surface 67d), and extending along the optical axis from the fourth side of the housing end surface in the direction away from the housing end surface, and
the first conductive member includes:
a bottom surface portion (bottom surface portion 71) at least partially located between an inner surface (inner surface 69e) of the housing end surface and an outer surface (outer surface 69f) of the housing end surface, and having a second shape at least including a fifth side (fifth side 71a), a sixth side (sixth side 71b), a seventh side (seventh side 71c), and an eighth side (eighth side 71d) in a plan view of the first conductive member;
a first side surface portion (first side surface portion 72a) at least partially extending from the fifth side of the bottom surface portion along the optical axis in a direction away from the bottom surface portion and located between the first inner side surface and the first outer side surface of the first wall of the second tubular portion of the housing;
a second side surface portion (second side surface portion 72b) at least partially extending from the sixth side of the bottom surface portion along the optical axis in the direction away from the bottom surface portion and located between the second inner side surface and the second outer side surface of the second wall of the second tubular portion of the housing;
a third side surface portion (third side surface portion 72c) at least partially extending from the seventh side of the bottom surface portion along the optical axis in the direction away from the bottom surface portion and located between the third inner side surface and the third outer side surface of the third wall of the second tubular portion of the housing; and
a fourth side surface portion (fourth side surface portion 72d) at least partially extending from the eighth side of the bottom surface portion along the optical axis in the direction away from the bottom surface portion and located between the fourth inner side surface and the fourth outer side surface of the fourth wall of the second tubular portion of the housing.

Accordingly, the first conductive member that accommodates at least the circuit board and the imaging element has the bottom surface portion and the side surface portion. At least a part of the bottom surface portion is disposed between the inner surface of the housing end surface and the outer surface of the housing end surface, and at least a part of the side surface portion is disposed between the inner side surface and the outer side surface of the wall of the second tubular portion of the housing. Thus, it is possible to reduce a distance between the inner surface of the housing and a component such as a circuit board disposed inside the housing, and improve a heat dissipation effect.
(2) The vehicular camera according to (1), in which
a first end portion (first end portion 73a) of the first side surface portion of the first conductive member is exposed to an inside of the housing from a part of the first inner side surface of the first wall of the second tubular portion of the housing,
a second end portion (second end portion 73b) of the second side surface portion of the first conductive member is exposed to the inside of the housing from a part of the second inner side surface of the second wall of the second tubular portion of the housing,
a third end portion (third end portion 73c) of the third side surface portion of the first conductive member is exposed to the inside of the housing from a part of the third inner side surface of the third wall of the second tubular portion of the housing, and
a fourth end portion (fourth end portion 73d) of the fourth side surface portion of the first conductive member is exposed to the inside of the housing from a part of the fourth inner side surface of the fourth wall of the second tubular portion of the housing.

Accordingly, since the end portion of the side surface portion of the first conductive member is exposed to the inside of the housing, a connection with another conductive member can be secured, and the degree of freedom in designing a shielding effect by the conductive member can be increased.
(3) The vehicular camera according to (2), further including:
a second conductive member (second conductive member 75) at least partially disposed between the lens barrel and the circuit board, in which
the second conductive member includes:
a planar portion (planar portion 76) having a third shape including at least a ninth side (ninth side 76a), a tenth side (tenth side 76b), an eleventh side (eleventh side 76c), and a twelfth side (twelfth side 76d) in a plan view of the second conductive member; and
a first contact portion (first contact portion 77a) that is brought into contact with the first end portion of the first side surface portion of the first conductive member via a first contact (first contact 77a1).

Accordingly, since the second conductive member in contact with the first conductive member is provided, the shielding effect can be improved.
(4) The vehicular camera according to (3), in which
the second conductive member further includes:
a second contact portion (second contact portion 77b) that is brought into contact with the second end portion of the second side surface portion of the first conductive member via a second contact (second contact 77b1);
a third contact portion (third contact portion 77c) that is brought into contact with the third end portion of the third side surface portion of the first conductive member via a third contact (third contact 77c1); and
a fourth contact portion (fourth contact portion 77d) that is brought into contact with the fourth end portion of the fourth side surface portion of the first conductive member via a fourth contact (fourth contact 77d1).

Accordingly, since the second conductive member is brought into contact with the first conductive member via at least four contacts, the shielding effect by the second conductive member can be reliably ensured.
(5) The vehicular camera according to (4), in which
the second conductive member further includes:
a first protrusion (first protrusion 78a) protruding from a first portion (first portion 76a1) of the ninth side of the planar portion toward an inner surface of the first end portion of the first conductive member;
a second protrusion (second protrusion 78b) protruding from a second portion (second portion 76b1) of the tenth side of the planar portion toward an inner surface of the second end portion of the first conductive member;
a third protrusion (third protrusion 78c) protruding from a third portion (third portion 76c1) of the eleventh side of the planar portion toward an inner surface of the third end portion of the first conductive member; and
a fourth protrusion (fourth protrusion 78d) protruding from a fourth portion (fourth portion 76d1) of the twelfth side of the planar portion toward an inner surface of the fourth end portion of the first conductive member,
the first end portion of the first side surface portion of the first conductive member is brought into contact with the first protrusion of the second conductive member via the first contact,
the second end portion of the second side surface portion of the first conductive member is brought into contact with the second protrusion of the second conductive member via the second contact,
the third end portion of the third side surface portion of the first conductive member is brought into contact with the third protrusion of the second conductive member via the third contact, and
the fourth end portion of the fourth side surface portion of the first conductive member is brought into contact with the fourth protrusion of the second conductive member via the fourth contact.

Accordingly, since the protrusion protruding from the planar portion of the second conductive member is brought into contact with the end portion of the side surface portion of the first conductive member via the contact, the contact between the first conductive member and the second conductive member can be made more reliable.
(6) The vehicular camera according to (1), in which
the circuit board has a fourth shape including at least a thirteenth side (thirteenth side 41a), a fourteenth side (fourteenth side 41b), a fifteenth side (fifteenth side 41c), and a sixteenth side (sixteenth side 41d) in a plan view of the circuit board,
the circuit board includes a first circuit board end surface (first circuit board end surface 41a1) corresponding to the thirteenth side, a second circuit board end surface (second circuit board end surface 41b1) corresponding to the fourteenth side, a third circuit board end surface (third circuit board end surface 41c1) corresponding to the fifteenth side, and a fourth circuit board end surface (fourth circuit board end surface 41d1) corresponding to the sixteenth side,
at least a part of the first inner side surface of the first wall of the second tubular portion of the housing faces the first circuit board end surface of the circuit board,
at least a part of the second inner side surface of the second wall of the second tubular portion of the housing faces the second circuit board end surface of the circuit board,
at least a part of the third inner side surface of the third wall of the second tubular portion of the housing faces the third circuit board end surface of the circuit board, and
at least a part of the fourth inner side surface of the fourth wall of the second tubular portion of the housing faces the fourth circuit board end surface of the circuit board.

Accordingly, the circuit board can be efficiently disposed inside the second tubular portion of the housing.
(7) The vehicular camera according to (1), further including:
a first resin member (first resin member 90) having predetermined thermal conductivity and disposed at least between the second surface of the circuit board and the inner surface of the housing end surface of the housing.

Accordingly, the first resin member can reduce the space between the second surface of the circuit board and the inner surface of the housing end surface, and can further improve the heat dissipation effect on the heat generated in the internal component.
(8) The vehicular camera according to (6), in which
the first resin member is disposed
between the first inner side surface of the first wall of the second tubular portion of the housing and the first circuit board end surface of the circuit board,
between the second inner side surface of the second wall of the second tubular portion of the housing and the second circuit board end surface of the circuit board,
between the third inner side surface of the third wall of the second tubular portion of the housing and the third circuit board end surface of the circuit board, and
between the fourth inner side surface of the fourth wall of the second tubular portion of the housing and the fourth circuit board end surface of the circuit board.

Accordingly, since the first resin member is also disposed between the inner side surface of the wall of the second tubular portion of the housing and the end surface of the circuit board, the heat dissipation effect can be further improved.
(9) The vehicular camera according to (7), in which
the inner surface of the housing end surface of the housing has a plurality of first recesses (first recesses 69e1) corresponding to a plurality of first electronic components (first electronic components 42) disposed on the second surface of the circuit board.

Accordingly, since the first recesses of the inner surface of the housing end surface correspond to the first electronic components disposed on the second surface of the circuit board, a gap between the inner surface of the housing end surface and the second surface of the circuit board can be reduced, and the heat dissipation effect can be improved.
(10) The vehicular camera according to (9), in which
the first resin member is disposed between the plurality of first electronic components disposed on the second surface of the circuit board and the plurality of first recesses of the inner surface of the housing end surface of the housing.

Accordingly, since the first resin member is also disposed between the first electronic components and the first recesses, the heat dissipation effect can be further improved.
(11) The vehicular camera according to (5), further including:
a lens barrel bracket (lens barrel bracket 32) made of a resin, at least a part of which is disposed between the lens barrel and the first surface of the circuit board, in which
the lens barrel bracket includes:
a first bracket surface (first bracket surface 32a);
a second bracket surface (second bracket surface 32b) that is opposite to the first bracket surface and at least partially faces the first surface of the circuit board; and
a bracket end surface (bracket end surface 32c) that connects the first bracket surface and the second bracket surface and includes at least a first bracket end surface (first bracket end surface 32c1), a second bracket end surface (second bracket end surface 32c2), a third bracket end surface (third bracket end surface 32c3), and a fourth bracket end surface (fourth bracket end surface 32c4),
at least a part of the planar portion of the second conductive member is located between the first bracket surface and the second bracket surface of the lens barrel bracket,
at least a part of the first protrusion of the second conductive member is exposed from the first bracket end surface,
at least a part of the second protrusion of the second conductive member is exposed from the second bracket end surface,
at least a part of the third protrusion of the second conductive member is exposed from the third bracket end surface, and
at least a part of the fourth protrusion of the second conductive member is exposed from the fourth bracket end surface.

Accordingly, since at least a part of the planar portion of the second conductive member is disposed inside the lens barrel bracket, a distance between the second bracket surface of the lens barrel bracket and the component such as the circuit board disposed inside the housing can be reduced, and the heat dissipation effect can be improved.
(12) The vehicular camera according to (11), further including:
a second resin member (second resin member 95) having predetermined thermal conductivity and disposed at least between the first surface of the circuit board and the second bracket surface of the lens barrel bracket.

Accordingly, a space between the first surface of the circuit board and the second bracket surface of the lens barrel bracket can be reduced, and the heat dissipation effect on the heat generated in the internal component can be further improved.
(13) The vehicular camera according to (12), in which
the second bracket surface of the lens barrel bracket has a plurality of second recesses (second recesses 32b1) corresponding to a plurality of second electronic components (second electronic components 43) disposed on the first surface of the circuit board.

Accordingly, since the second recesses of the second bracket surface correspond to the second electronic components disposed on the first surface of the circuit board, it is possible to reduce a gap between the second bracket surface and the second surface of the circuit board and improve the heat dissipation effect.
(14) The vehicular camera according to (13), in which
the second resin member is disposed between the plurality of second electronic components disposed on the first surface of the circuit board and the plurality of second recesses of the second bracket surface of the lens barrel bracket.

Accordingly, since the second resin member is also disposed between the second electronic components and the second recesses, the heat dissipation effect can be further improved.
(15) The vehicular camera according to (12), in which
the second resin member is disposed to surround the imaging element disposed on the first surface of the circuit board.

Accordingly, it is possible to improve the heat dissipation effect while ensuring the function of the imaging element.
(16) The vehicular camera according to (11), in which
at least a part of the second bracket surface of the lens barrel bracket is bonded to the first surface of the circuit board with at least one adhesive (adhesive 38).

Accordingly, the circuit board can be stably disposed inside the second tubular portion of the housing.
(17) The vehicular camera according to (11), in which
the lens barrel bracket has a first hole (first hole 32d) corresponding to the optical axis and penetrating the first bracket surface and the second bracket surface, and
the second conductive member has a second hole (second hole 76e) corresponding to the first hole in the planar portion.

Accordingly, the first hole of the lens barrel bracket and the second hole of the second conductive member correspond to each other, and thus light from the outside can be introduced into the inside of the housing.
(18) The vehicular camera according to (17), in which
the bottom surface portion of the first conductive member has a third hole (third hole 71e) penetrating the bottom surface portion,
the housing has a fourth hole (fourth hole 69g) corresponding to the third hole and penetrating the housing end surface,
the vehicular camera further includes a connector (connector 80) that penetrates the third hole and the fourth hole and is electrically connected to the circuit of the circuit board, and
the first resin member is disposed to surround the connector.

Accordingly, the connector can ensure electrical connection between the vehicular camera, the outside, and a power supply.
(19) The vehicular camera according to (18), in which
the connector includes:
a first connector end (first connector end 81) disposed inside the housing and electrically connected to the circuit of the circuit board; and
a second connector end (second connector end 82) opposite to the first connector end and disposed in the fourth hole of the housing end surface of the housing, and
when the vehicular camera is disposed in a vehicle, the second connector end of the connector is electrically connected to a wire of the vehicle.

Accordingly, the connector can ensure electrical connection between the vehicular camera and the wire of the vehicle.
(20) The vehicular camera according to (12), in which
the first resin member and the second resin member include a magnetic material.

Accordingly, the shielding effect can also be imparted to the resin member.

Although the embodiments have been described above with reference to the accompanying drawings, the present disclosure is not limited thereto. It is apparent to a person skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, components in the embodiment described above may be combined freely in a range without departing from the gist of the invention.

### INDUSTRIAL APPLICABILITY

The present disclosure is useful as a vehicular camera capable of reducing a distance between an inner surface of a housing and a component such as a circuit board disposed inside the housing and improving a heat dissipation effect.

### CROSS-REFERENCE TO RELATED APPLICATIONS

This application is based on and claims priority under 35 USC 119 from Japanese Patent Application No. 2024-030433 filed on Oct. 20, 2023, the contents of which are incorporated herein by reference.

What is claimed is:

1. A vehicular camera comprising:
a lens barrel including a first tubular portion having a first tubular shape along an optical axis and at least one lens disposed inside the first tubular portion and on the optical axis;
a circuit board including a first surface and a second surface opposite to the first surface;
an imaging element electrically connected to a circuit of the circuit board and disposed on the first surface of the circuit board on the optical axis;
a first conductive member disposed to accommodate at least the circuit board and the imaging element; and
a housing made of a resin and disposed to accommodate at least the circuit board and the imaging element, the housing including a second tubular portion having a second tubular shape along the optical axis, wherein
the second tubular portion of the housing includes:
a housing end surface that at least partially faces the second surface of the circuit board and has a first shape including at least a first side, a second side, a third side, and a fourth side in a plan view of the housing;
a first wall having a first inner side surface and a first outer side surface, and extending along the optical axis from the first side of the housing end surface in a direction away from the housing end surface;
a second wall having a second inner side surface and a second outer side surface, and extending along the optical axis from the second side of the housing end surface in the direction away from the housing end surface;
a third wall having a third inner side surface and a third outer side surface, and extending along the optical axis from the third side of the housing end surface in the direction away from the housing end surface; and
a fourth wall having a fourth inner side surface and a fourth outer side surface, and extending along the optical axis from the fourth side of the housing end surface in the direction away from the housing end surface, and
the first conductive member includes:
a bottom surface portion at least partially located between an inner surface of the housing end surface and an outer surface of the housing end surface, and having a second shape at least including a fifth side, a sixth side, a seventh side, and an eighth side in a plan view of the first conductive member;
a first side surface portion at least partially extending from the fifth side of the bottom surface portion along the optical axis in a direction away from the bottom surface portion and located between the first inner side surface and the first outer side surface of the first wall of the second tubular portion of the housing;
a second side surface portion at least partially extending from the sixth side of the bottom surface portion along the optical axis in the direction away from the bottom surface portion and located between the second inner side surface and the second outer side surface of the second wall of the second tubular portion of the housing;
a third side surface portion at least partially extending from the seventh side of the bottom surface portion along the optical axis in the direction away from the bottom surface portion and located between the third inner side surface and the third outer side surface of the third wall of the second tubular portion of the housing; and
a fourth side surface portion at least partially extending from the eighth side of the bottom surface portion along the optical axis in the direction away from the bottom surface portion and located between the fourth inner side surface and the fourth outer side surface of the fourth wall of the second tubular portion of the housing.

2. The vehicular camera according to claim 1, wherein
a first end portion of the first side surface portion of the first conductive member is exposed to an inside of the housing from a part of the first inner side surface of the first wall of the second tubular portion of the housing,
a second end portion of the second side surface portion of the first conductive member is exposed to the inside of the housing from a part of the second inner side surface of the second wall of the second tubular portion of the housing,
a third end portion of the third side surface portion of the first conductive member is exposed to the inside of the housing from a part of the third inner side surface of the third wall of the second tubular portion of the housing, and
a fourth end portion of the fourth side surface portion of the first conductive member is exposed to the inside of the housing from a part of the fourth inner side surface of the fourth wall of the second tubular portion of the housing.

3. The vehicular camera according to claim 2, further comprising:
a second conductive member at least partially disposed between the lens barrel and the circuit board, wherein
the second conductive member includes:
a planar portion having a third shape including at least a ninth side, a tenth side, an eleventh side, and a twelfth side in a plan view of the second conductive member; and
a first contact portion that is brought into contact with the first end portion of the first side surface portion of the first conductive member via a first contact.

4. The vehicular camera according to claim 3, wherein
the second conductive member further includes:
a second contact portion that is brought into contact with the second end portion of the second side surface portion of the first conductive member via a second contact;
a third contact portion that is brought into contact with the third end portion of the third side surface portion of the first conductive member via a third contact; and
a fourth contact portion that is brought into contact with the fourth end portion of the fourth side surface portion of the first conductive member via a fourth contact.

5. The vehicular camera according to claim 4, wherein
the second conductive member further includes:
a first protrusion protruding from a first portion of the ninth side of the planar portion toward an inner surface of the first end portion of the first conductive member;
a second protrusion protruding from a second portion of the tenth side of the planar portion toward an inner surface of the second end portion of the first conductive member;
a third protrusion protruding from a third portion of the eleventh side of the planar portion toward an inner surface of the third end portion of the first conductive member; and
a fourth protrusion protruding from a fourth portion of the twelfth side of the planar portion toward an inner surface of the fourth end portion of the first conductive member,
the first end portion of the first side surface portion of the first conductive member is brought into contact with the first protrusion of the second conductive member via the first contact,
the second end portion of the second side surface portion of the first conductive member is brought into contact with the second protrusion of the second conductive member via the second contact,
the third end portion of the third side surface portion of the first conductive member is brought into contact with the third protrusion of the second conductive member via the third contact, and
the fourth end portion of the fourth side surface portion of the first conductive member is brought into contact with the fourth protrusion of the second conductive member via the fourth contact.

6. The vehicular camera according to claim 5, wherein
the circuit board has a fourth shape including at least a thirteenth side, a fourteenth side, a fifteenth side, and a sixteenth side in a plan view of the circuit board,
the circuit board includes a first circuit board end surface corresponding to the thirteenth side, a second circuit board end surface corresponding to the fourteenth side, a third circuit board end surface corresponding to the fifteenth side, and a fourth circuit board end surface corresponding to the sixteenth side,
at least a part of the first inner side surface of the first wall of the second tubular portion of the housing faces the first circuit board end surface of the circuit board,
at least a part of the second inner side surface of the second wall of the second tubular portion of the housing faces the second circuit board end surface of the circuit board,
at least a part of the third inner side surface of the third wall of the second tubular portion of the housing faces the third circuit board end surface of the circuit board, and
at least a part of the fourth inner side surface of the fourth wall of the second tubular portion of the housing faces the fourth circuit board end surface of the circuit board.

7. The vehicular camera according to claim 6, further comprising:
a first resin member having predetermined thermal conductivity and disposed at least between the second surface of the circuit board and the inner surface of the housing end surface of the housing.

8. The vehicular camera according to claim 7, wherein
the first resin member is disposed between the first inner side surface of the first wall of the second tubular portion of the housing and the first circuit board end surface of the circuit board, between the second inner side surface of the second wall of the second tubular portion of the housing and the second circuit board end surface of the circuit board, between the third inner side surface of the third wall of the second tubular portion of the housing and the third circuit board end surface of the circuit board, and between the fourth inner side surface of the fourth wall of the second tubular portion of the housing and the fourth circuit board end surface of the circuit board.

9. The vehicular camera according to claim 7, wherein
the inner surface of the housing end surface of the housing has a plurality of first recesses corresponding to a plurality of first electronic components disposed on the second surface of the circuit board.

10. The vehicular camera according to claim 9, wherein
the first resin member is disposed between the plurality of first electronic components disposed on the second surface of the circuit board and the plurality of first recesses of the inner surface of the housing end surface of the housing.

11. The vehicular camera according to claim 7, further comprising:
a lens barrel bracket made of a resin, at least a part of which is disposed between the lens barrel and the first surface of the circuit board, wherein
the lens barrel bracket includes:
a first bracket surface;
a second bracket surface that is opposite to the first bracket surface and at least partially faces the first surface of the circuit board; and
a bracket end surface that connects the first bracket surface and the second bracket surface and includes at least a first bracket end surface, a second bracket end surface, a third bracket end surface, and a fourth bracket end surface,
at least a part of the planar portion of the second conductive member is located between the first bracket surface and the second bracket surface of the lens barrel bracket,
at least a part of the first protrusion of the second conductive member is exposed from the first bracket end surface,
at least a part of the second protrusion of the second conductive member is exposed from the second bracket end surface,
at least a part of the third protrusion of the second conductive member is exposed from the third bracket end surface, and
at least a part of the fourth protrusion of the second conductive member is exposed from the fourth bracket end surface.

12. The vehicular camera according to claim 11, further comprising:
a second resin member having predetermined thermal conductivity and disposed at least between the first surface of the circuit board and the second bracket surface of the lens barrel bracket.

13. The vehicular camera according to claim 12, wherein
the second bracket surface of the lens barrel bracket has a plurality of second recesses corresponding to a plurality of second electronic components disposed on the first surface of the circuit board.

14. The vehicular camera according to claim 13, wherein
the second resin member is disposed between the plurality of second electronic components disposed on the first surface of the circuit board and the plurality of second recesses of the second bracket surface of the lens barrel bracket.

15. The vehicular camera according to claim 12, wherein
the second resin member is disposed to surround the imaging element disposed on the first surface of the circuit board.

16. The vehicular camera according to claim 11, wherein
at least a part of the second bracket surface of the lens barrel bracket is bonded to the first surface of the circuit board with at least one adhesive.

17. The vehicular camera according to claim 11, wherein
the lens barrel bracket has a first hole corresponding to the optical axis and penetrating the first bracket surface and the second bracket surface, and
the second conductive member has a second hole corresponding to the first hole in the planar portion.

18. The vehicular camera according to claim 17, wherein
the bottom surface portion of the first conductive member has a third hole penetrating the bottom surface portion,
the housing has a fourth hole corresponding to the third hole and penetrating the housing end surface,
the vehicular camera further includes a connector that penetrates the third hole and the fourth hole and is electrically connected to the circuit of the circuit board, and
the first resin member is disposed to surround the connector.

19. The vehicular camera according to claim 18, wherein
the connector includes:
a first connector end disposed inside the housing and electrically connected to the circuit of the circuit board; and
a second connector end opposite to the first connector end and disposed in the fourth hole of the housing end surface of the housing, and
when the vehicular camera is disposed in a vehicle, the second connector end of the connector is electrically connected to a wire of the vehicle.

20. The vehicular camera according to claim 12, wherein
the first resin member and the second resin member include a magnetic material.
